(19) United States
(12) Patent Application Publication
(10) Pub. No.: US 2007/0256792 A1
(43) Pub. Date: Nov. 8, 2007

(54) Temperature indicative tape

(76) Inventors: Shannon Reading, Easton, PA (US); Dennis Redline, Piscataway, NJ (US); Shobha Puntambekar, Morganville, NJ (US)

Correspondence Address: FLETCHER YODER (ILLINOIS TOOL WORKS INC.), P.O. BOX 692289, HOUSTON, TX, 77269-2289, US

(21) Appl. No.: 11/418,764

(22) Filed: May 5, 2006

(51) Int. Cl. B65C 9/18

(52) U.S. Cl. 156/574; 156/238

(57) ABSTRACT

A system that, in certain embodiments, may include a packing tape dispenser and a packing tape mountable in the packing tape dispenser. In some embodiments, the packing tape comprises a plurality of layers, including a substrate layer, an adhesive layer, and a thermochromic layer.

### BACKGROUND

The present invention relates generally to tape and, in certain embodiments, to temperature indicating tape.

Often, temperature sensitive materials are damaged during shipping or storage. For example, the performance of some chemical products suffers when they have been exposed to temperatures that are either too cold or too hot. Complicating matters, it is frequently difficult to control the temperature of these materials during shipping and/or storage. Frequently, third parties specializing in shipping and storage are responsible for the temperature sensitive materials for extended periods. These third parties may not precisely monitor the temperature within their shipping containers or warehouses. Further, temperature controls in warehouses and shipping containers often fail, and shipped materials may be exposed to the elements while on receiving docks. Unfortunately, it is often difficult to determine if temperature sensitive materials were exposed to damaging temperatures. As a result, it may be difficult to guarantee the performance or quality of temperature sensitive materials.

### BRIEF DESCRIPTION

The following describes, in part, a system that, in certain embodiments, may include a packing tape dispenser and a packing tape mountable in the packing tape dispenser. In some embodiments, the packing tape comprises a plurality of layers, including a substrate layer, an adhesive layer, and a thermochromic layer.

### DRAWINGS

These and other features, aspects, and advantages of the present invention will become better understood when the following detailed description is read with reference to the accompanying drawings in which like characters represent like parts throughout the drawings, wherein:

FIG. 1 is an illustration of an exemplary taping system having temperature indicative tape in accordance with an embodiment of the present technique;

FIG. 2 is an illustration of the exemplary taping system in operation in accordance with an embodiment of the present technique;

FIG. 3 is a cross-sectional view of an exemplary temperature indicative tape in accordance with an embodiment of the present technique; and

FIGS. 4-6 are top views of exemplary temperature indicative tapes in accordance with an embodiment of the present technique.

### DETAILED DESCRIPTION

As discussed in detail below, some of the embodiments of the present technique provide a method and apparatus for determining if an object has been exposed to temperatures outside of some range. Further, certain embodiments discussed below may robustly secure an object while indicating if the object has been exposed to temperatures outside of the range. Of course, such embodiments are merely exemplary of the present technique, and the appended claims should not be viewed as limited to those embodiments. Indeed, the present technique is applicable to a wide variety of systems, devices, and methods.

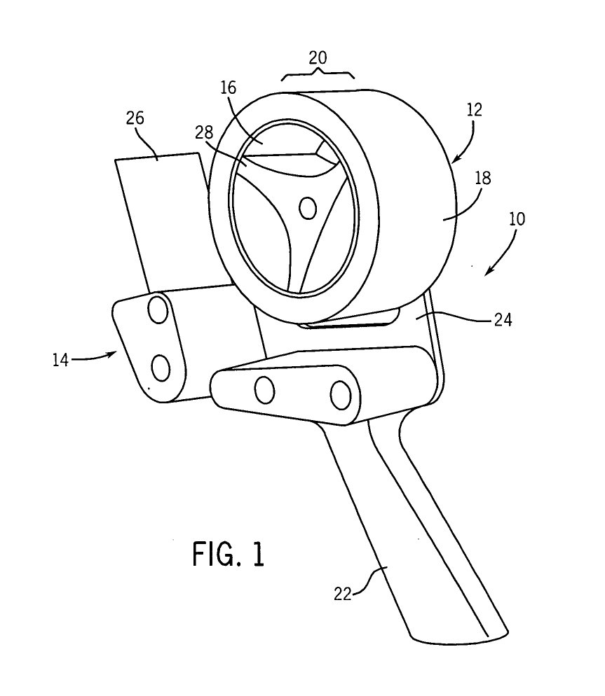

FIG. 1 depicts an exemplary taping system 10 having a roll of temperature indicative tape 12 and a tape dispenser 14. In other words, the roll of temperature indicative tape 12 is sensitive to temperature changes, levels, or ranges to indicate one or more indicia to a user. As discussed in detail below, the temperature indicative tape 56 may change color, highlight text or patterns, emphasize a particular temperature condition, or generally provide information indicative of a temperature exposure in one or more portions on the tape 12. The present taping system 10 is a manual tape dispensing system. Accordingly, the present roll of tape 12 is sized for a manual tape dispenser and the present tape dispenser 14 is a manual tape dispenser. Of course, other embodiments may include other types of taping systems 10, such as an automatic tape dispensing system having an automatic tape dispenser 14 and a roll of tape 12 sized for such a taping system 10. It should also be noted that other embodiments in accordance with the present technique may not include a roll of tape 12 or a tape dispenser 14, which is not to suggest that any other feature discussed herein may not also be omitted.

In the present embodiment, the roll of tape 12 may include a core 16 and temperature indicative tape 18. The core 16 may have a generally right cylindrical shape and include cardboard or other appropriate materials, such as plastic, paper, or wood, for example. Alternatively, the core 16, like many of the other features discussed herein, may be omitted.

The temperature indicative tape 18 may be configured to indicate exposure to a temperature and reliably secure an object, as is discussed in greater detail below. For example, the roll of tape 12 may include a thermochromic tape, an irreversible thermochromic tape, a thermochromic packing tape, an irreversible thermochromic packing tape, a temperature responsive tape, and/or a temperature responsive packing tape. The roll of tape 12 and tape 18 may have a tape width 20 greater than 1, 2, 3, 4, 5, 6, 7, 8, 9, or 10 centimeters, or more. The tape 18 may be wrapped around the core 16.

In the current embodiment, the tape dispenser 14 may include a handle 22, a chassis 24, an applicator 26, and a reel 28. The present handle 22 and applicator 26 may be generally secured to the chassis 24, and the reel 28 may be rotatably secured to the chassis 24. The reel 28 may rotate about an axis that is generally perpendicular to the chassis 24 and the handle 22. The applicator 26 may extend from the handle 22 on a side of the roll of tape 12 from which tape 18 is typically dispensed. The roll of tape 12 may be disposed about the reel 28, and the core 16 may be frictionally engaged with the reel 28.

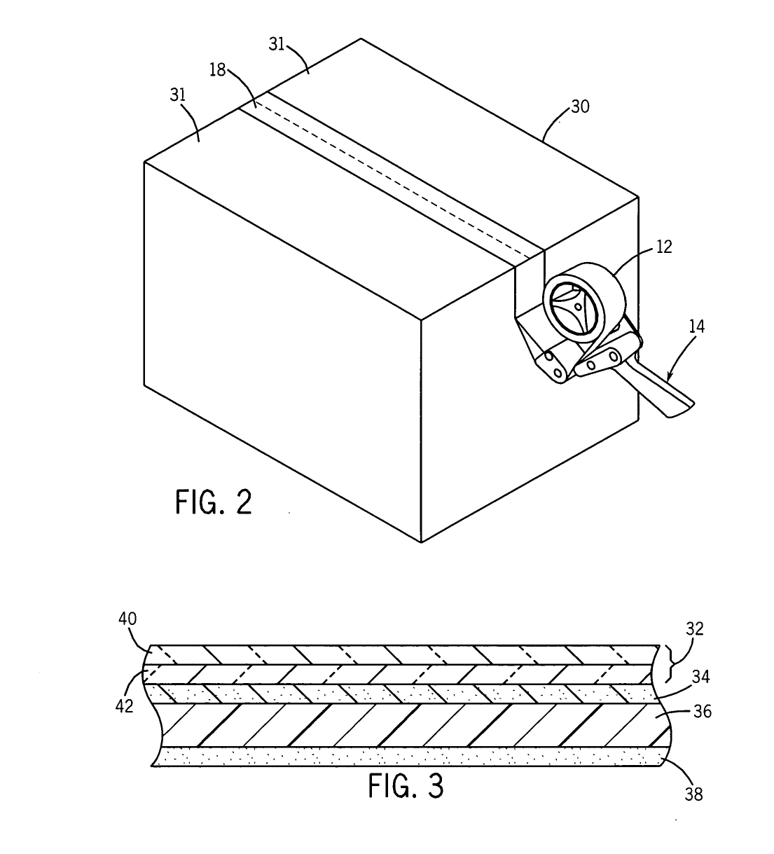

The operation of the exemplary taping system 10 is depicted by FIG. 2. A box, package, or object 30, which may include temperature sensitive materials, is taped closed or generally secured with tape 18. As the tape dispenser 14 is drawn across the top of the box 30, the reel 28 may rotate, and the tape 18 may unwind from the roll of tape 12. The applicator 26 may press the tape 18 against the box 20. In the present embodiment, an adhesive portion of the tape 18, which is described in more detail below, may adhere to the box 30 and secure the box 30. To this end, the tape 18 may close the box 30, for instance by holding one or more lid portions or flaps 31 of the box 30 closed.

In some embodiments, the temperature indicative tape 18 is strong enough to secure the box 30 during shipping. For instance, the tape 18 may have a tensile strength greater than 5, 10, 15, 20, 25, 30, 35, 40, 45, 50, 55, 60, 65, 70, 75, 80, 85, 90, 95, or 100 pounds per inch or more. Further, the tape 18 may have an adhesion greater than 5, 10, 15, 20, 25, 30, 35, 40, 45, 50, 55, 60, 65, 70, 75, 80, 85, 90, 95, or 100 ounces per inch to steel at a 180 degree peel, or more. In some embodiments the tape 18 may conform to certain standards, such as the standards promulgated in ASTM D5486/D5486M-04, ASTM D5486 Type III, CID A-A-1684B, ASTM D5570 for water resistance, or other standards, for example.

Further, the temperature indicative tape 18 may indicate if the box 30 or the tape 18 has been exposed to temperatures outside of a certain range. For example, in certain embodiments, the tape 18 may indicate exposure to temperatures greater than 10, 20, 30, 32, 40, 50, 60, 70, 80, 90, 100, 110, 120, 130, 140, 150, 200, 212, 250, or 300 degrees Fahrenheit for longer than 1 second, 10 seconds, 30 seconds, 1 minute, 2 minutes, 5 minutes, 10 minutes, 15 minutes, 20 minutes, 25 minutes, 30 minutes, 45 minutes, 1 hour, 5 hours, or 1 day, for example. Alternatively, or additionally, the tape 18 may indicate exposure to temperatures less than 10, 20, 30, 32, 40, 50, 60, 70, 80, 90, 100, 110, 120, 130, 140, 150, 200, 212, 250, or 300 degrees Fahrenheit for longer than 1 second, 10 seconds, 30 seconds, 1 minute, 2 minutes, 5 minutes, 10 minutes, 15 minutes, 20 minutes, 25 minutes, 30 minutes, 45 minutes, 1 hour, 5 hours, or 1 day, for example.

In some embodiments, the temperature indicative tape 18 indicates exposure to a temperature by changing color. That is, the tape 18 may be thermochromic. The tape 18 may appear to the naked eye to have changed color when exposed to one of the temperature ranges discussed above for longer than one of the time periods discussed above. As used herein, the temperature at which the tape 18 substantially changes color is referred to as the “thermochromic response temperature,” and the time period that the tape takes to substantially change color is referred to as the “thermochromic response time.” In some embodiments, the tape 18 may change from a single first color to a single second color when exposed to a certain temperature range for longer than a certain time period. Of course, in other embodiments, the tape 18 may change color through a range of colors in response to the magnitude of temperature or the duration of time at certain temperatures. In some embodiments, the tape 18 may assume a color that generally corresponds with the amount of heat transfer into or out of an object at a first temperature that has been exposed to an environment at a second temperature for some duration. In some embodiments, the color change may be substantially irreversible and/or permanent.

FIG. 3 depicts a cross section of an exemplary temperature indicative tape 18 having a plurality of layers 32, 34, 36, and 38, wherein at least one layer includes a temperature indicative material and at least one layer includes a mechanically strong material. In various embodiments, the number and arrangement of the layers may be altered to provide desired mechanical strength, adhesion, water resistance, temperature indicative characteristics, and so forth. In some embodiments, the layers 32, 34, 36, and 38 of the temperature indicative tape 18 may correspond to a protective layer 32, a temperature indicator layer 34, a substrate 36, and an adhesive layer 38. The protective layer 32 may, in some embodiments, include an acrylic emulsion layer 40 and a styrene butyl emulsion layer 42. Of course, some embodiments may not include a protective layer 32 or one or both of the layers 40 or 42, which is not to suggest that other features may not also be omitted. The temperature indicator layer 34 may include a thermochromic ink, such as Security Ink or Thermal Ink, available from Tempil, Inc. of South Plainfield, N.J. The thermochromic ink may have one or more of the various thermochromic response times and temperatures discussed above in reference to the tape 18. In some embodiments, the thermochromic ink responds to a dry heat temperature. The thermochromic ink may be flexographically printed, silkscreened, or applied in some other manner. The other layers 32, 36, and 38 of the present tape 18 are available from Canadian Technical Tape Ltd. of Montreal, Quebec (Canada).

The present substrate 36 may include, in some embodiments, materials that provide mechanical strength to the tape 18, such as polypropylene or other plastics, paper or other fibers, and/or foil, for example. Further, some embodiments may include an arrangement of fibers, for example a plurality of strips or a grid of fiberglass, plastic, wood, and/or cellulose fibers, that may supplement the strength and/or toughness of the substrate 36.

The layers of the temperature indicative tape 18 may be sequenced as depicted in FIG. 3 or the layers of the tape 18 may be in a different sequence. For instance, the temperature indicator layer 34 may be disposed under the substrate 36 and the substrate may be generally translucent or transparent. In such an embodiment, the temperature indicator layer 34 may be disposed between the substrate 36 and the adhesive layer 38. Other embodiments may also include a non-temperature responsive patterned layer. For instance, a printed legend may be placed near the temperature indicator layer 34, in the same layer or in another layer. In fact, a wide variety of materials and sequences of layers can embody the present technique.

Advantageously, some embodiments of the temperature indicative tape 18 may facilitate transport and/or storage of temperature sensitive materials. The tape 18 may substantially simultaneously mechanically secure a package 30, monitor the temperature of the package 30, and/or indicate if the package 30 has been exposed temperatures beyond some specified range for some specified time period. Thus, applying the tape 18 to a package 30 may, in certain embodiments, both secure the package 30 mechanically and provide a basis on which to believe that the materials in the package 30 have not been exposed to damaging temperatures. For example, the package 30 may contain temperature sensitive drugs, medicine, blood samples, surgical implants (e.g., heart livers, etc.), tumors and removed tissues (e.g., brain, lung, etc.), food, milk, chemicals, biotech agents, photographic film, and so forth. The temperature indicative tape 18 may have a thermochromic response time and/or temperature based on a temperature exposure time limit for a package contents.

Of course, applications of the tape 18 are not limited to shipping and storage. In some embodiments, the tape 18 may be used to determine if an object has completed some thermal processing step. For example, the tape 18 may be applied to an object before it is placed in an oven, and the color of the tape 18 may indicate if the object has been sufficiently heated by the oven. Alternatively, the tape 18 may be used to indicate some unsafe condition. For example, the tape 18 may indicate if an object is too hot or too cold to touch or if some surface is likely to be coated with ice.

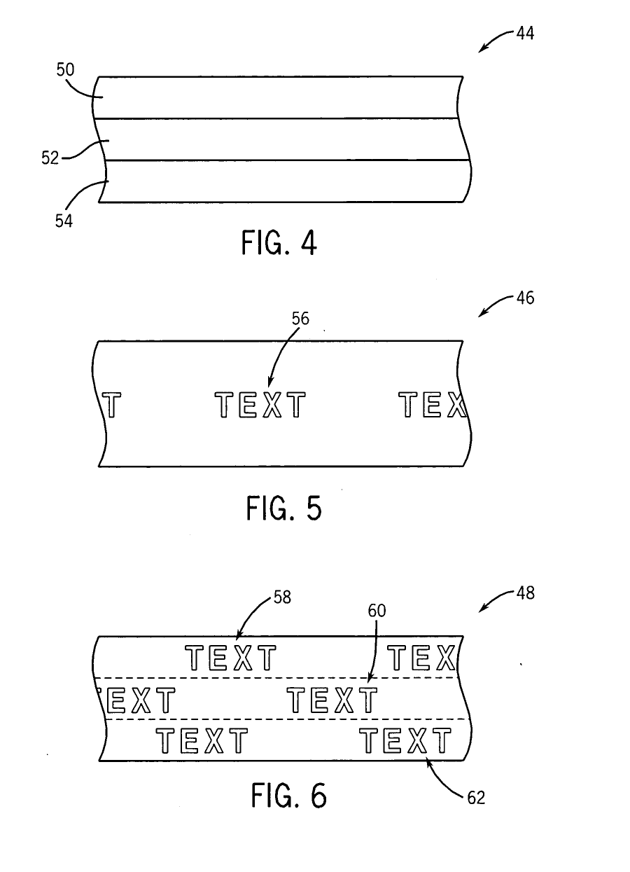

Turning to FIGS. 4-6, the top view of three exemplary tapes 44, 46, and 48 are depicted. The tapes 44, 46, and 48 may include the layers discussed in reference to the tape 18 in FIG. 3 and may be employed within the taping system 10 discussed in reference to FIGS. 1 and 2. As illustrated by FIG. 4, the tape 44 may include an array of patterned temperature indicator regions 50, 52, and 54, such as parallel strips. In the present embodiment, each of these temperature indicator regions 50, 52, and 54 may be patterned with an ink responsive to a different temperature range, duration of exposure, or both. For instance, the temperature indicator regions 50, 52, and 54 may be printed with thermochromic ink. The three regions 50, 52, and 54 may be disposed in the temperature indicator layer 34 or they may be disposed in different layers. Further, explanatory text, symbols, and/or figures may be printed in or on the tape 44 to, in some embodiments, explain the significance of a temperature response, such as a color change, in one of the temperature indicator regions 50, 52, and 54.

Temperature indicator regions may be printed or otherwise applied in a variety of patterns. For instance, FIG. 5 depicts an exemplary tape 46 with patterned temperature indicator text 56. Temperature indicator text 56 may be printed with a temperature indicator or responsive material, such as thermochromic ink, for instance. The temperature indicator text 56 may convey some warning, such as “damaged goods,” “goods out of specification,” “warning,” or “damaged in transit.” In some embodiments, the region surrounding the text 56 may be patterned with a non-temperature responsive ink of the same color as an un-reacted thermochromic ink in the text 56. That is, the text 56 may blend into the surrounding field of the tape 46 until the thermochromic ink in the text 56 is exposed to conditions that change its color.

In another variant, FIG. 6 depicts an exemplary tape 48 with a plurality of texts 58, 60, and 62. In the present embodiment, thermochromic inks used to print each region of text 58, 60, and 62 respond to different temperature ranges, durations of exposure, or both. The text 58, 60, and 62 may display a different message based on their constituent ink. For instance, text 58 may display a warning message, text 60 may display a message indicating a high likelihood that goods are damaged, and text 62 may display a message indicating a near certainty that goods are damaged. Of course, a wide variety of printed, patterned, and blanket layers of temperature responsive materials are envisioned as part of embodiments in accordance with the present technique.

1. An apparatus, comprising:
a packing tape dispenser; and
a packing tape mountable in the packing tape dispenser, wherein the packing tape comprises a plurality of layers, comprising:
a substrate layer;
an adhesive layer; and
a thermochromic layer.

2. The apparatus of claim 1, wherein the thermochromic layer has a thermochromic response time based on a temperature exposure time limit for a package contents.

3. The apparatus of claim 1, wherein the thermochromic layer has a thermochromic response temperature based on a temperature exposure level for a package contents.

4. The apparatus of claim 1, wherein the thermochromic layer comprises a generally irreversible thermochromic layer.

5. The apparatus of claim 1, wherein the thermochromic layer has a thermochromic response temperature and time based on limits for medicine, tissue, blood, chemicals, plants, animals, food, drinks, biotech agents, photographic film, or combinations thereof.

6. The apparatus of claim 1, wherein the thermochromic layer, or a plurality of thermochromic layers including the thermochromic layer, comprises a plurality of different thermochromic regions with different thermochromic chararteristics.

7. The apparatus of claim 6, wherein the plurality of different thermochromic regions include adjacent areas, parallel strips, text, symbols, figures, or combinations thereof.

8. The apparatus of claim 1, comprising an at least translucent or transparent layer disposed between the thermochromic layer and a surface of the packing tape.

9. The apparatus of claim 8, wherein the at least translucent or transparent layer comprises an acrylic emulsion and a butyl styrene emulsion.

10. The apparatus of claim 1, wherein the packing tape has a tensile strength greater than 35 pounds per inch.

11. The apparatus of claim 1, wherein the packing tape has an adhesion greater than 25 ounces per inch to steel at a 180 degree peel.

12. The apparatus of claim 1, wherein the substrate layer comprises polypropylene and has a tensile strength greater than 15 pounds per inch.

13. The apparatus of claim 1, wherein the thermochromic layer includes a first region responsive to a first temperature exposure over a first duration and a second region responsive to a second temperature exposure over a second duration, wherein either the first duration is different from the second duration or the first temperature is different from the second temperature.

14. An apparatus, comprising:
thermochromic packing tape configured to mechanically secure an object and indicate exposure of the object to a first temperature range for more than a first time period.

15. The apparatus of claim 14, wherein the thermochromic packing tape has a thermochromic response time based on a temperature exposure time limit for a package contents.

16. The apparatus of claim 14, wherein the thermochromic packing tape has a thermochromic response temperature based on a temperature exposure level for a package contents.

17. The apparatus of claim 14, wherein the thermochromic packing tape comprises a plurality of different thermochromic regions with different thermochromic chararteristics.

18. The apparatus of claim 17, wherein the plurality of different thermochromic regions include adjacent areas, parallel strips, text, symbols, figures, or combinations thereof.

19. The apparatus of claim 14, comprising an object packaged by the thermochromic packing tape.

20. The apparatus of claim 19, wherein the object includes medicine, tissue, blood, chemicals, plants, animals, food, drinks, biotech agents, photographic film, or combinations thereof.

21. A method, comprising:
providing a temperature indicative packing tape having a thermal response time, a response temperature, and a temperature indicia.

22. The method of claim 21, wherein providing comprises adhering the temperature indicative tape to a package.

23. The method of claim 21, wherein providing comprises mechanicaly securing at least part of a package with the temperature indicative packing tape.

24. The method of claim 21, wherein providing comprises transporting a package having the temperature indicative packing tape disposed on the package.

25. A method, comprising:
displaying indicia of a thermal history of a package via a temperature indicative or responsive portion of a packing tape disposed on the package.

26. The method of claim 25, wherein displaying indicia of the thermal history comprises monitoring and recording temperature conditions of the package via the tempetature indicative or responsive portion.
